(19) United States
(12) Patent Application Publication
(10) Pub. No.: US 2021/0293638 A1
(43) Pub. Date: Sep. 23, 2021

(54) ANALYSIS APPARATUS, ANALYSIS METHOD, AND COMPUTER PROGRAM PRODUCT

(71) Applicants: KABUSHIKI KAISHA TOSHIBA, Minato-ku (JP); CANON MEDICAL SYSTEMS CORPORATION, Otawara-shi (JP)

(72) Inventors: Mitsuaki KATO, Kawasaki (JP); Kenji HIROHATA, Koto (JP); Akira KANO, Kawasaki (JP); Akihiro GORYU, Kanazawa (JP)

(73) Assignees: KABUSHIKI KAISHA TOSHIBA, Minato-ku (JP); CANON MEDICAL SYSTEMS CORPORATION, Otawara-shi (JP)

(21) Appl. No.: 17/004,081

(22) Filed: Aug. 27, 2020

(30) Foreign Application Priority Data
Mar. 17, 2020 (JP) 2020-046180

(51) Int. Cl. G01L 5/00

(52) U.S. Cl. CPC G01L 5/00

(57) ABSTRACT

An analysis apparatus of an embodiment includes one or more processors. The processors receive structural information indicating a structure of a pipe to be analyzed and fluid information indicating a state of a fluid flowing in the pipe. The one or more processors obtain a plurality of loss factors of the pipe based on the structural information and the fluid information and calculate a wall shear stress of the pipe from the loss factors.

### CROSS-REFERENCE TO RELATED APPLICATIONS

This application is based upon and claims the benefit of priority from Japanese Patent Application No. 2020-046180, filed on Mar. 17, 2020; the entire contents of which are incorporated herein by reference.

### FIELD

An embodiment described herein relates generally to an analysis apparatus, an analysis method, and a computer program product.

A technique for performing fluid analysis of a pipe having the known structure and simulating fluid distribution has been proposed. It may be preferable to calculate a wall shear stress (WSS) of a pipe in order to analyze a part where clogging of the pipe occurs or a part where damage in the pipe occurs.

### BACKGROUND

The problem to be solved by an embodiment described herein is to provide an analysis apparatus, an analysis method, and a computer program capable of calculating a wall shear stress (WSS) of a pipe with higher accuracy.

### BRIEF DESCRIPTION OF THE DRAWINGS

FIG. 1 is a cross-sectional view of a pipe cut on a cross section parallel to a moving direction of a fluid;

FIG. 2 is a block diagram illustrating an analysis apparatus according to a present embodiment;

FIG. 3 is a view illustrating an example of structural information on an elliptic pipe;

FIG. 4 is a view illustrating an example of structural information on a bent pipe;

FIG. 5 is a view illustrating an example of structural information on a branched pipe;

FIG. 6 is a view illustrating an example of structural information on an expanding pipe;

FIG. 7 is a flowchart of analysis processing in the present embodiment; and

FIG. 8 is a view illustrating an example of blood vessels to be analyzed.

### DETAILED DESCRIPTION

According to one embodiment, an analysis apparatus according to an embodiment includes one or more processors. The processors receive structural information indicating a structure of a pipe to be analyzed and fluid information indicating a state of a fluid flowing in the pipe. The one or more processors obtain a plurality of loss factors of the pipe based on the structural information and the fluid information and calculate a wall shear stress of the pipe from the loss factors.

A preferable embodiment of an analysis apparatus according to this disclosure will now be described in detail with reference to the accompanying drawings.

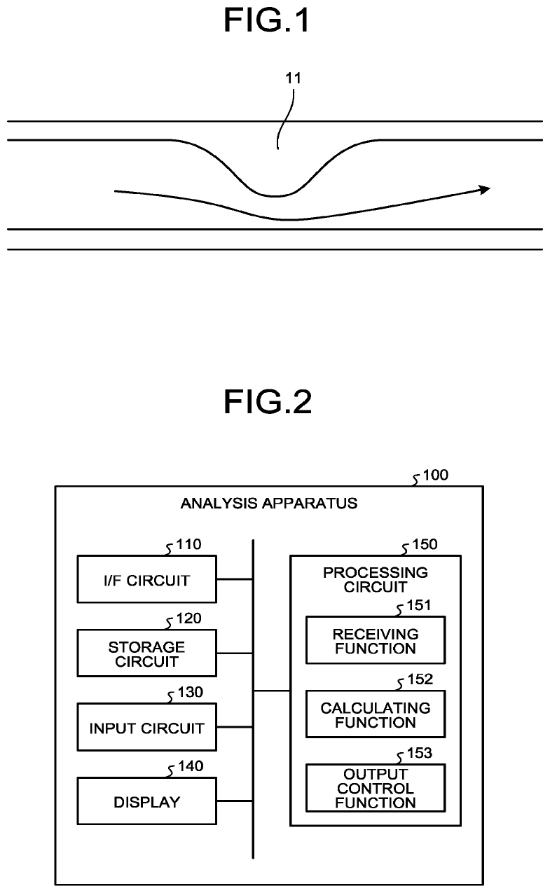

FIG. 1 is a view illustrating an example of a pipe to be analyzed. FIG. 1 is an example of a cross-sectional view of a pipe cut on a cross section parallel to a moving direction of a fluid. The pipe to be analyzed may be any pipe (flow path) in which a fluid flows. Examples of the pipe to be analyzed may be artificial flow paths such as piping in a plant and may be flow paths such as blood vessels in which blood as a fluid flows. Examples of the artificial pipes may be pipes in which liquid as a fluid flows (a water supplying pipe, a water distributing pipe, a drainage pipe, and the like) and pipes in which gas as a fluid flows (an air supply pipe, an exhaust pipe, and the like).

As illustrated in FIG. 1, on a wall of a pipe in which a fluid flows, an object 11 (deposit and plaque) may be attached. In an area where a wall shear stress (WSS) is small, the object 11 is likely to be attached and/or accumulated. By contrast, in an area where a WSS is large, the object 11 and a pipe wall are likely to be peeled and/or damaged. Thus, it is preferable to predict a WSS with higher accuracy in order to analyze a part where clogging of a pipe occurs because of the object 11 attached to the pipe or a part where damage in the pipe occurs.

A WSS of a pipe is derived using, for example, Expression (1). Expression (1) is derived based on the fact that an acting force of a pressure loss caused by a friction loss of a pipe and a frictional force due to a WSS are balanced with each other. In Expression (1), τW, r, and dp/dx represent a WSS, a radius of a pipe, and a gradient of pressure (p) (pressure gradient) of the pipe in a length direction (x), respectively.

$${τ}_{w} = - \frac{r}{2} \frac{d p}{d x} \qquad ( 1 )$$

A WSS is changed depending on the structure (shape) of a pipe and a state of a flow. An analysis apparatus of the present embodiment obtains a plurality of loss factors of a pipe depending on the structure of the pipe and a state of a flow, and calculates a WSS from the loss factors. In this manner, the analysis apparatus can calculate a WSS of a pipe with higher accuracy, thereby, preliminarily analyzing, for example, a degree that an object is attached to the inside of the pipe.

FIG. 2 is a diagram illustrating a structural example of an analysis apparatus 100 according to the present embodiment. The analysis apparatus 100 calculates and outputs, from structural information indicating the structure of an input pipe and the like, a WSS of the pipe. The analysis apparatus 100 is implemented by computer equipment such as a workstation.

For example, the analysis apparatus 100 includes an interface (I/F) circuit 110, a storage circuit 120, an input circuit 130, a display 140, and a processing circuit 150.

The I/F circuit 110 is connected to the processing circuit 150, and controls transmission and communication of various kinds of data with an external apparatus. For example, the I/F circuit 110 receives structural information indicating the structure of a pipe to be analyzed and fluid information indicating a state of a fluid flowing in the pipe from an external apparatus, and outputs the received information to the processing circuit 150. For example, the I/F circuit 110 is implemented by a network card, a network adapter, a network interface controller (NIC), and the like.

Various kinds of information used by the analysis apparatus 100 such as structural information and fluid information are not necessarily input (received) from an external apparatus through the I/F circuit 110. A method for reading such information from a storage medium storing therein the information so as to input the read information and a method for using information input by the input circuit 130, which will be described later, may be applied. In this case, the analysis apparatus 100 does not necessarily include the I/F circuit 110.

The storage circuit 120 is connected to the processing circuit 150, and stores therein various kinds of data. The storage circuit 120 stores therein, for example, structural information and fluid information received from an external apparatus. For example, the storage circuit 120 is implemented by a random access memory (RAM), a semiconductor memory device such as flash memory, a hard disk, an optical disk, and the like.

The input circuit 130 is connected to the processing circuit 150, and converts an input operation received from an operator into an electrical signal and outputs the electrical signal to the processing circuit 150. For example, the input circuit 130 is implemented by a trackball, a switch button, a mouse, a keyboard, a touch panel, and the like.

The display 140 is connected to the processing circuit 150, and displays various kinds of information and various kinds of image data output from the processing circuit 150. For example, the display 140 is implemented by a liquid-crystal display, a cathode ray tube (CRT) monitor, a touch panel, and the like.

The display 140 is an example of output apparatuses outputting information. A method for outputting information is not limited to a method for displaying information on the display 140. As the method for outputting information, a method for outputting information to an external apparatus through a network and the like, a method for outputting information as sound to audio output apparatuses (such as a speaker), and the like may be applied.

The processing circuit 150 controls each component included in the analysis apparatus 100 depending on an input operation received from an operator through the input circuit 130. Specifically, the processing circuit 150 causes the storage circuit 120 to store therein structural information and fluid information output from the I/F circuit 110. In addition, the processing circuit 150 reads the structural information and fluid information from the storage circuit 120, and calculates a WSS and the displays the calculated WSS on the display 140.

The processing circuit 150 includes a receiving function 151 (example of a receiving unit), a calculating function 152 (example of a calculating unit), and an output control function 153 (example of an output control unit).

The receiving function 151 receives various kinds of information used for processing performed by the processing circuit 150. For example, the receiving function 151 receives structural information and fluid information by reading the structural information and the fluid information from the storage circuit 120.

Any information may be defined as structural information if the information is information indicating the structure of a pipe to be analyzed. Examples of the structural information include at least one of the following: a radius of a pipe, a diameter of the pipe, a length of the pipe, an oblateness of an elliptic pipe, a magnification ratio of an expanding pipe, a reduction ratio of a contracted pipe, a curvature radius of the pipe, and a branch angle of a branched pipe.

Any information may be defined as fluid information if the information is information indicating the inside of a pipe and a state of the boundary of an intended pipe. The fluid information can use at least one of the following parameters: a viscosity factor of a fluid, the density of the fluid, the velocity of the fluid (fluid velocity), and pressure of the fluid. The fluid information may include any index value that can be calculated by combining these parameters with each other.

The calculating function 152 calculates a WSS of a pipe using structural information and fluid information. For example, the calculating function 152 obtains a plurality of loss factors of a pipe from the structural information and the fluid information, and calculates a WSS from the obtained loss factors. Details of a method for calculating a WSS through the calculating function 152 will be described later.

The output control function 153 controls output of output information based on the calculated WSS. The output information is at least one of the information indicating the calculated WSS and the information indicating an index that is calculated by the calculated WSS. Examples of the index include an index indicating a function of a pipe related to constriction. When a pipe is a blood vessel, examples of the index include a myocardial fractional flow reserve (FFR), a dynamic index in the blood vessel, and a blood flow volume index.

The processing circuit 150 is implemented by, for example, one or more processors. For example, each of the functions (the receiving function, the calculating function, and the output control function) described above may be implemented by causing a processor such as a central processing unit (CPU) to execute a computer program, in other words, software. Each of the functions may be implemented by a processor such as a dedicated integrated circuit (IC), in other words, hardware. Each of the functions may be implemented with a combination of software and hardware. When a plurality of processors are used, each processor may implement one function out of the functions, and may implement two or more functions out of the functions.

A computer program executed by the analysis apparatus according to the present embodiment is preliminarily incorporated in the storage circuit 120 and the like so as to be provided.

The computer program executed by the analysis apparatus according to the present embodiment may be a file in an installable format or in an executable format, and be recorded in computer-readable recording media such as a compact disc read only memory (CD-ROM), a flexible disk (FD), a compact disc recordable (CD-R), and a digital versatile disc (DVD) so as to be provided as a computer program product.

Furthermore, the computer program executed by the analysis apparatus according to the present embodiment may be stored in a computer connected to a network such as the Internet and be downloaded through the network so as to be provided. The computer program executed by the analysis apparatus according to the present embodiment may be provided or distributed through a network such as the Internet.

The computer program executed by the analysis apparatus according to the present embodiment enables a computer to function as each function of the analysis apparatus described above. After the processing circuit 150 reads the computer program on a main storage apparatus from a computer-readable storage medium, this computer can execute the computer program.

Details of a method for calculating a WSS through the calculating function 152 will be described. The calculating function 152 calculates a WSS by the following Expression (2).

$${τ}_{w} = {\sum }_{i = 1}^{n} {λ}_{i} \frac{ρ {v}^{2}}{8} \qquad ( 2 )$$

Expression (2) can be derived from Expression (1) as below. The following Expression (3) represents a relational expression between a pressure loss Δp due to a flow of a fluid in a pipe and the average fluid velocity (Darcy-Weisbach Equation). In Expression (3), λ, 1, d, ρ, and v represent a loss factor, a length of a pipe, a diameter of the pipe, the density of a fluid, and the average fluid velocity of the fluid, respectively.

$$Δ p = - λ \frac{l}{d} \frac{ρ {v}^{2}}{2} \qquad ( 3 )$$

Expression (3) can be interpreted as an expression that considers only one loss factor λ in order to calculate a pressure loss of a pipe. Examples of the loss factor include a pipe friction factor.

In the present embodiment, a pressure loss of a pipe is calculated by the following Expression (4) that extends Expression (3) and considers a plurality of loss factors. In Expression (4), n is the total number of considered loss factors, and λᵢ (1≤i≤n) is a plurality of loss factors.

$$Δ p = {\sum }_{i = 1}^{n} Δ {p}_{i} = - {\sum }_{i = 1}^{n} {λ}_{i} \frac{l}{d} \frac{ρ {v}^{2}}{2} \qquad ( 4 )$$

Examples of the loss factors include at least one of the following: a loss factor because a pipe is an elliptic pipe, a loss factor because a pipe is an expanding pipe, a loss factor because a pipe is a contracted pipe, a loss factor because a pipe is a bent pipe, and a loss factor because a pipe is a branched pipe. As indicated in Expression (4), the calculating function 152 adds a plurality of pressure losses obtained using the loss factors so as to estimate a pressure loss of a pipe.

A pressure gradient can be represented as shown in Expression (5).

$$\frac{d p}{d x} = \frac{Δ p}{l} \qquad ( 5 )$$

The following Expression (6) can be obtained by substituting Expressions (4) and (5) into Expression (1). Expression (2) described above can be obtained by organizing Expression (6).

$${τ}_{w} = \frac{r}{2 l} {\sum }_{i = 1}^{n} {λ}_{i} \frac{l}{d} \frac{ρ {v}^{2}}{2} \qquad ( 6 )$$

Various kinds of pressure losses may include not only losses on a wall surface but also other losses caused by a vortex and the like. Thus, the calculating function 152 may calculate a WSS by using a predetermined correction factor αᵢ as shown in Expression (7).

$${τ}_{w} = {\sum }_{i = 1}^{n} {α}_{i} {λ}_{i} \frac{ρ {v}^{2}}{8} \qquad ( 7 )$$

The correction factor αᵢ is a correction factor for separating contribution of a wall surface loss in a pressure loss from other losses caused by a vortex and the like. Generally, the contribution ratio of a wall surface loss in a pressure loss and of other losses caused by a vortex and the like is unclear. Thus, an optimized correction factor is obtained by, for example, performing parametric study, and the obtained correction factor is stored in, for example, the storage circuit 120. The calculating function 152 calculates a WSS based on Expression (7) using the correction factor αᵢ read from the storage circuit 120.

The calculating function 152 calculates each loss factor λᵢ depending on the received structural information. The calculating function 152 calculates a WSS by substituting the calculated loss factor and the density ρ and the velocity v included in the received fluid information into Expression (2) or (7).

A method for calculating each loss factor λ₁, depending on structural information may be any method that has been conventionally used. The following describes examples of a method for calculating a loss factor depending on the kind of the structure.

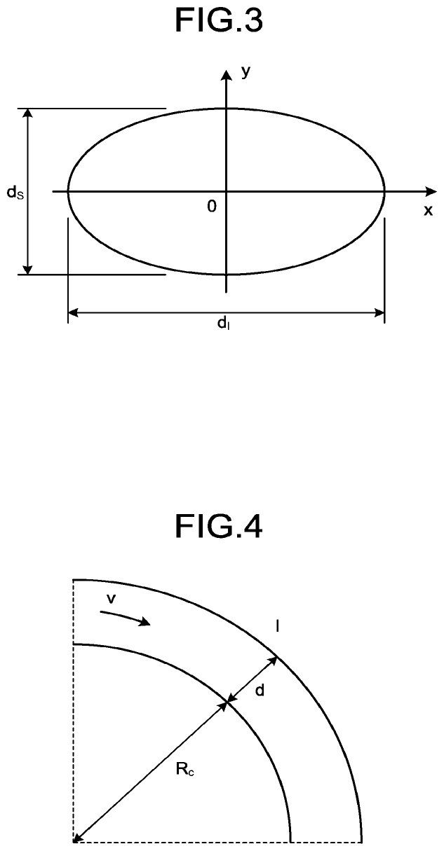

Specific examples of the structure of pipes and the corresponding structural information will be described with reference to FIGS. 3 to 6. FIGS. 3, 4, 5, and 6 are views illustrating examples of the structural information on an elliptic pipe, a bent pipe, a branched pipe, and an expanding pipe, respectively.

When a pipe is an elliptic pipe, a length d₅ of a minor axis and a length d₁ of a major axis illustrated in FIG. 3, and besides, a length l of the pipe, a ratio α of the length d_{c} of the minor axis to the length d of the major axis, the oblateness, and the like can be defined as structural information.

As illustrated in FIG. 4, when a pipe is a bent pipe, a curvature radius R of the pipe, a length l of the pipe, a diameter d of the pipe, and the like can be defined as structural information. In addition, v represents the velocity of a fluid described above.

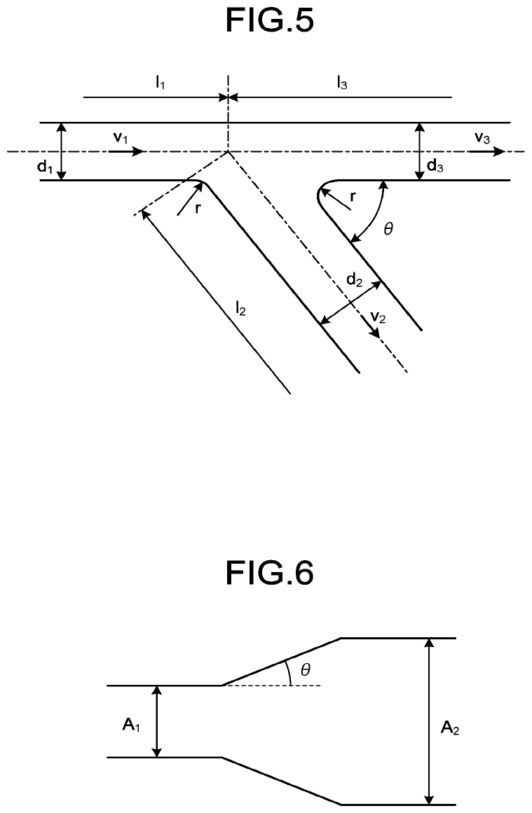

As illustrated in FIG. 5, when pipes are a branched pipe, the respective lengths l₁ to l₃ of the pipes, the respective diameters d₁ to d₃ of the pipes, a branch angle θ, the fillet radius r, and the like can be defined as structural information. The velocities v₁ to v₃ represent the velocity of the respective fluids flowing in the pipes. FIG. 5 illustrates an example in which a pipe is branched into two, but the pipe may be branched into three or more.

As illustrated in FIG. 6, when a pipe is an expanding pipe, a diameter A₁ of an inlet, a diameter A₂ of an outlet, an expansion angle θ, and the like can be defined as structural information.

The calculating function 152 can calculate, for example, a loss factor λᵢ corresponding to an elliptic pipe by the following Expression (8). In Expression (8), E( ) represents the complete elliptic integral of the second kind.

$${λ}_{i} = \frac{32}{R e} {( 1 + {α}^{2} ) [ \frac{π}{E ( \sqrt{1 - {( \frac{{d}_{s}}{{d}_{l}} )}^{2}} )} ]}^{2} \qquad ( 8 )$$

Re is a Reynolds number, and can be calculated based on the following Expression (9). In Expression (9), μ is a viscosity factor of a fluid.

$$R e = \frac{ρ v d}{μ} \qquad ( 9 )$$

The calculating function 152 may obtain a loss factor with a calculation expression (for example, Expression (8)) for obtaining a loss factor corresponding to structural information and fluid information, and may obtain a loss factor using correspondence information for obtaining a loss factor corresponding to structural information and fluid information. Examples of the correspondence information include information in which the structural information and the fluid information correspond to a loss factor.

A method for calculating a loss factor for a branched pipe will be described. When the pipe is a branched pipe that is branched into two, the calculating function 152 refers to, for example, correspondence information in which a loss factor to a ratio of velocity v₂ to velocity v₁ (v₂/v₁) is corresponded so as to calculate a loss factor. The velocity v₂ and the velocity v₁ can be obtained from fluid information. The correspondence information is determined for each structural information such as a branch angle θ. The calculating function 152 calculates a loss factor λ using the correspondence information corresponding to the structural information.

A method for calculating a loss factor for an expanding pipe will be described. When a pipe is an expanding pipe, the calculating function 152 refers to, for example, correspondence information in which a pressure recovery ratio η to an expansion angle θ is corresponded so as to calculates the pressure recovery ratio η.

The calculating function 152 can calculate a loss factor λ from the following Expression (10) using the calculated pressure recovery ratio η, diameter A₁ of an inlet, and a diameter A₂ of an outlet.

$$λ = d ( 1 - η ) \{ 1 - {( \frac{{A}_{1}}{{A}_{2}} )}^{2} \} \qquad ( 10 )$$

A method for calculating a WSS is not limited to each of the expressions described above. Any method may be defined as the method for calculating a WSS if the method is a method for obtaining a plurality of loss factors of a pipe based on structural information and fluid information and calculating a WSS from the obtained loss factors.

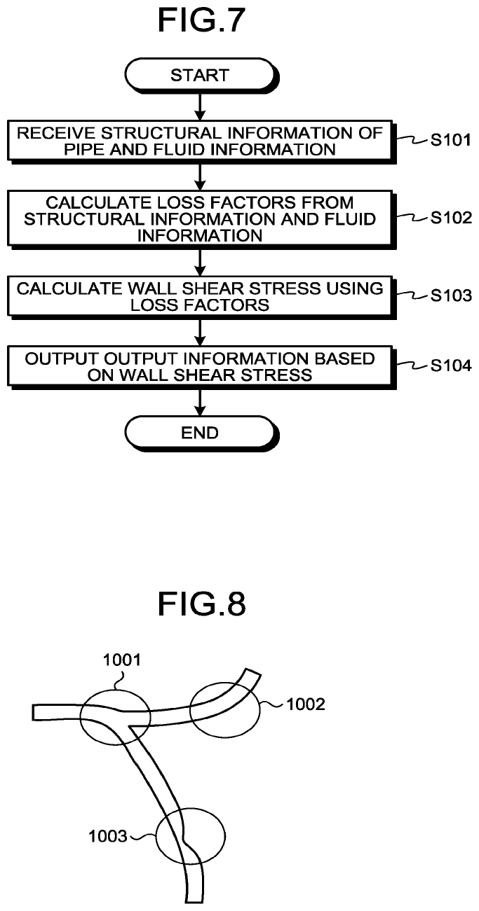

The following describes analysis processing performed by the analysis apparatus 100 according to the present embodiment formed in this manner. FIG. 7 is a flowchart illustrating an example of analysis processing in the present embodiment.

The receiving function 151 receives structural information of a pipe to be analyzed and fluid information of a fluid flowing in the pipe (step S101). The calculating function 152 calculates a plurality of correction factors (loss factors λᵢ) using the received structural information and fluid information through the procedures described above (step S102). The calculating function 152 calculates a WSS by substituting the calculated loss factors λᵢ, and the density ρ and the velocity v included in the fluid information into Expression (2) or (7) (step S103). The output control function 153 controls, for example, the display 140 to output (display) output information based on the calculated WSS thereon (step S104), and ends the analysis processing.

As described above, pipes to be analyzed may be artificial pipes such as piping and may be vessels such as blood vessels and lymph vessels guiding blood and a lymph fluid within a living organism. FIG. 8 is a view illustrating an example of vessels to be analyzed. Whether pipes are artificial pipes or vessels of a living organism, actual pipes form a fluid network by combining a branched pipe 1001, a bent pipe 1002, an expanding pipe (contracted pipe) 1003, and the like as illustrated in FIG. 8. There may be cases, which are not illustrated in FIG. 8, where a pipe cross section is not true circular but elliptic, and where a part has a closed curve having a distorted shape. As described at S101 and S102 in FIG. 7, a loss factor is calculated and assigned for each element of a fluid network so as to calculate a WSS with higher accuracy.

Structural information indicating the structure of this kind of fluid network may be preliminarily built using a computer-aided design (CAD) model and the like upon simulation, and may be obtained by taking and analyzing an image of a pipe with image acquiring apparatuses such as an X-ray computed tomography (CT) apparatus, a magnetic resonance imaging (MRI) apparatus, and ultrasonic diagnostic equipment. By contrast, information on a fluid flowing in a pipe may be determined by preliminarily inspecting the nature of flowing liquid with a viscometer and the like, may use a typical value determined by the kind of the liquid, and may be calculated from the structure obtained from an apparatus obtaining the structural information described above by using physical calculation and statistical processing.

Using structural information and fluid information obtained by this kind of apparatus and received by the receiving function 151, the analysis apparatus 100 of the present embodiment can calculate a WSS of a blood vessel. In this manner, the analysis apparatus 100 can analyze, for example, a state of a blood clot (plaque) generated in a blood vessel.

In this manner, the analysis apparatus of the present embodiment obtains a plurality of loss factors depending on the structure of a pipe and a state of a fluid and calculates a WSS from the loss factors. Thus, the analysis apparatus can calculate a WSS with higher accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed:

1. An analysis apparatus comprising:
one or more processors configured to
receive structural information indicating a structure of a pipe to be analyzed and fluid information indicating a state of a fluid flowing in the pipe; and
obtain a plurality of loss factors of the pipe based on the structural information and the fluid information and calculate a wall shear stress of the pipe from the loss factors.

2. The analysis apparatus according to claim 1, wherein the one or more processors obtain values by multiplying a predetermined correction factor for each of the loss factors and calculate the wall shear stress of the pipe from the obtained values.

3. The analysis apparatus according to claim 1, wherein the one or more processors calculate the loss factors, using a calculation expression or corresponding information determined for each of the loss factors for obtaining the loss factors corresponding to the structural information and the fluid information, and calculate the wall shear stress from the loss factors.

4. The analysis apparatus according to claim 1, wherein the loss factors include at least one of the following: a loss factor because the pipe is an elliptic pipe, a loss factor because the pipe is an expanding pipe, a loss factor because the pipe is a contracted pipe, a loss factor because the pipe is a bent pipe, and a loss factor because the pipe is a branched pipe.

5. The analysis apparatus according to claim 1, wherein the structural information includes at least one of the following: a radius of the pipe, a diameter of the pipe, a length of the pipe, an oblateness of the pipe that is an elliptic pipe, a magnification ratio of the pipe that is an expanding pipe, a reduction ratio of the pipe that is a contracted pipe, a curvature radius of the pipe that is a bent pipe, and a branch angle of the pipe that is a branched pipe.

6. The analysis apparatus according to claim 1, wherein the fluid information includes at least one of the following: a viscosity factor of the fluid, the density of the fluid, the velocity of the fluid, and the pressure of the fluid.

7. The analysis apparatus according to claim 1, wherein the pipe is a pipe in which water flows as the fluid, a pipe in which gas flows as the fluid, or a blood vessel in which blood flows as the fluid.

8. The analysis apparatus according to claim 1, wherein the one or more processors control output of output information based on the calculated wall shear stress.

9. The analysis apparatus according to claim 8, wherein the output information is at least information indicating the calculated wall shear stress or information indicating an index calculated from the calculated wall shear stress.

10. An analysis method comprising:
receiving structural information indicating a structure of a pipe to be analyzed and fluid information indicating a state of a fluid flowing in the pipe; and
obtaining a plurality of loss factors of the pipe based on the structural information and the fluid information and calculating a wall shear stress of the pipe from the loss factors.

11. A computer program product having a non-transitory computer readable medium including programmed instructions, wherein the instructions, when executed by a computer, cause the computer to perform:
receiving structural information indicating a structure of a pipe to be analyzed and fluid information indicating a state of a fluid flowing in the pipe; and
obtaining a plurality of loss factors of the pipe based on the structural information and the fluid information and calculating a wall shear stress of the pipe from the loss factors.
